(19) United States
(12) Patent Application Publication
(10) Pub. No.: US 2025/0149015 A1
(43) Pub. Date: May 8, 2025

(54) HEAT PUMP WATER HEATER MUFFLER

(71) Applicant: Rheem Manufacturing Company, Atlanta, GA (US)

(72) Inventors: Michael Wood Hardy, Gainesvulle, GA (US); Veera Malayappan, Montgomery, AL (US); Miguel Angel Ubaldo Muñiz, Nuevo Laredo (MX); Burak Muhammed Adanur, Montgomery, AL (US); Alex L. Williams, Montgomery, AL (US)

(21) Appl. No.: 18/931,758

(22) Filed: Oct. 30, 2024

Related U.S. Application Data
(60) Provisional application No. 63/596,403, filed on Nov. 6, 2023.

(51) Int. Cl. G10K 11/172; F24H 4/04

(52) U.S. Cl. CPC G10K 11/172; F24H 4/04

(57) ABSTRACT

A heat pump water heater is disclosed. The heat pump water heater may include a housing having an air inlet and an air outlet. The heat pump water heater may further include a compressor disposed in a housing interior portion. The heat pump water heater may further include an inlet muffler and an outlet muffler. The inlet muffler may be disposed between the compressor and the air inlet, and the outlet muffler may be disposed between the compressor and the air outlet. The inlet muffler and the outlet muffler may be configured to reflect sound generated by the compressor back to the housing interior portion.

### CROSS-REFERENCE TO RELATED APPLICATIONS

This application claims priority to and the benefit of U.S. provisional application No. 63/596,403, filed Nov. 6, 2023, which is hereby incorporated by reference herein in its entirety.

### FIELD

The present disclosure relates to heat pump water heaters and more specifically to heat pump water heater mufflers that are configured to minimize sound transmission from compressors of the heat pump water heaters.

### BACKGROUND

Water heaters are generally used to provide a supply of heated water in a variety of applications, including residential, commercial, and industrial applications. Conventional water heaters use gas burners, electrical heating elements, and/or solar panels to heat water. Some modern water heaters also use heat pumps that heat water by extracting heat from ambient air by using a refrigerant.

A conventional heat pump water heater may include an air inlet that intakes the ambient air and an air outlet that exhausts cool and dehumidified air. The heat pump water heater may include an evaporator that extracts heat from the ambient air by using the refrigerant. The heat pump water heater also may include a compressor that may receive and compress the refrigerant. The compressed refrigerant may be used to heat water in a water storage tank.

In the conventional heat pump water heater, the compressor may generate mechanical noise or sound during operation. The sound waves may flow out of the heat pump water heater from the air inlet and/or the air outlet, which may not be desirable.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example water heater in accordance with one or more embodiments of the present disclosure.

FIG. 2 depicts a sectional top view of the water heater of FIG. 1 in accordance with one or more embodiments of the present disclosure.

FIG. 3 depicts a sectional side view of the water heater of FIG. 1 in accordance with one or more embodiments of the present disclosure.

FIG. 4 depicts a sectional front view of the water heater of FIG. 1 in accordance with one or more embodiments of the present disclosure.

### DETAILED DESCRIPTION

The present disclosure is directed towards a heat pump water heater that is configured to minimize sound transmission from a compressor installed in the heat pump water heater. Specifically, the heat pump water heater may include an inlet muffler and/or an outlet muffler that may prevent sound waves generated by the compressor to travel from an interior portion of the heat pump water heater to outside of the heat pump water heater. The inlet muffler may be disposed between the compressor and an air inlet disposed on a top or side wall of a heat pump water heater housing. The inlet muffler may prevent sound wave transmission via the air inlet. The outlet muffler may be disposed between the compressor and an air outlet disposed on a side or top wall of the heat pump water heater housing. The outlet muffler may prevent sound wave transmission via the air outlet.

In some aspects, the inlet muffler may include a first inlet baffle plate and a second inlet baffle plate. In some instances, the first inlet baffle plate and the second inlet baffle plate may be disposed parallel to each other. Further, the first inlet baffle plate and the second inlet baffle plate may be disposed at a first predefined distance from each other such that a gap may exist between the first inlet baffle plate and the second inlet baffle plate. Furthermore, in some instances, the first and second inlet baffle plates may be disposed at a housing top wall in proximity to the air inlet. In this manner, the first and second inlet baffle plates may allow ambient air to enter inside the heat pump water heater housing via the air inlet and the gap; however, the inlet baffle plates may prevent sound waves from traveling from housing interior portion to outside of the housing via the air inlet.

Similarly, the outlet muffler may include a first outlet baffle plate and a second outlet baffle plate. In some instances, the first outlet baffle plate and the second outlet baffle plate may be disposed parallel to each other and at a second predefined distance from each other, such that a gap may exist between the first and second outlet baffle plates. In certain embodiments, the first outlet baffle plate and the second outlet baffle plate may be disposed at a housing side wall in proximity to the air outlet. In this manner, the first and second outlet baffle plates may allow air to exit from the heat pump water heater housing via the air outlet and gap; however, the outlet baffle plates may prevent sound waves from traveling from the housing interior portion to outside of the housing via the air outlet.

In this manner, the inlet muffler and the outlet muffler may prevent sound waves from traveling from the housing interior portion to outside of the housing, thereby minimizing sound transmission from the compressor within the housing.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of being a system and method for heating water with a heat pump water heater. The present disclosure, however, is not so limited, and can be applicable in other contexts. The present disclosure, for example and not limitation, can include other water heater systems, such as boilers, pool heaters, industrial water heaters, and other water heater systems configured to heat water or any combination thereof. Furthermore, the present disclosure can include other fluid heating systems configured to heat a fluid other than water such as process fluid heaters used in industrial applications. Such implementations and applications are contemplated within the scope of the present disclosure. Accordingly, when the present disclosure is described in the context of being a system and method for heating water with the heat pump water heater, it will be understood that other implementations can take the place of those referred to.

Although the term “water” is used throughout this specification, it is to be understood that other fluids may take the place of the term “water” as used herein. Therefore, although described as a water heater system, it is to be understood that the system and methods described herein can apply to fluids other than water. Further, it is also to be understood that the term “water” can replace the term “fluid” as used herein unless the context clearly dictates otherwise.

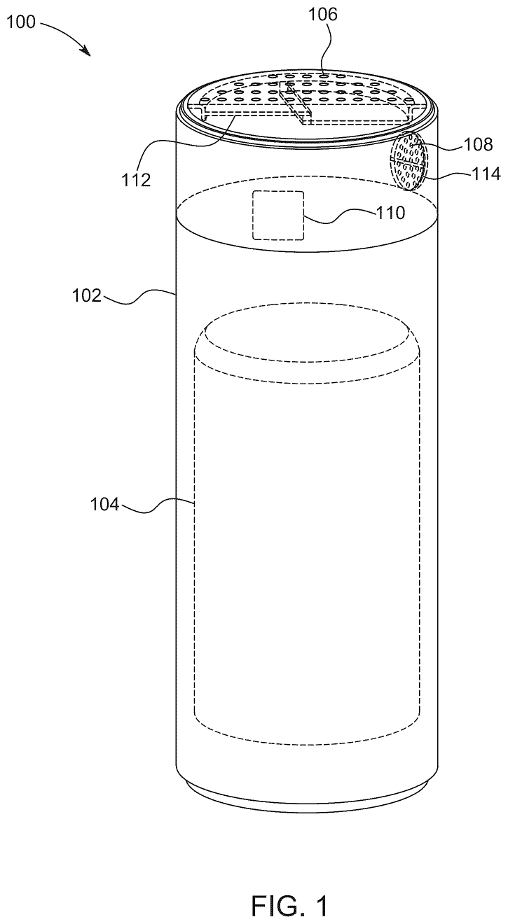

Turning now to the drawings, FIG. 1 depicts a water heater 100 (or a water heating device 100) in accordance with one or more embodiments of the present disclosure. The water heating device 100 may be configured to heat water or any other fluid. The water heating device 100 may include a housing 102 that may include a water storage tank 104 (or a fluid tank) for storing water or any fluid to be heated. In some aspects, the water heater 100 may be a tankless water heater (or an on-demand water heater) and may not necessarily require the water storage tank 104. The tankless water heater may heat water instantaneously without storing the water in a water tank, e.g., the water storage tank 104.

The water storage tank 104 (and/or the housing 102) may be any suitable size, shape, or configuration based on the water heating device application. For example, the water storage tank 104 may be sized for common residential use or for commercial or industrial use that may require greater amounts of heated water. Furthermore, the water storage tank 104 may be made of any suitable material for storing and heating water, including copper, carbon steel, stainless steel, ceramics, polymers, composites, or any other suitable material. The water storage tank 104 may also be treated or lined with a coating to prevent corrosion and leakage. The water storage tank 104 may be treated or coated with any suitable coating that may be capable of withstanding temperature and pressure of the water heating device 100 and may include, as non-limiting examples, glass enameling, galvanizing, thermosetting resin-bonded lining materials, thermoplastic coating materials, cement coating, or any other suitable treating or coating for the application. Optionally, the water storage tank 104 may be insulated to retain heat. For example, the water storage tank 104 may be insulated using foam, fiberglass, aluminum foil, organic material, or any other suitable insulation material.

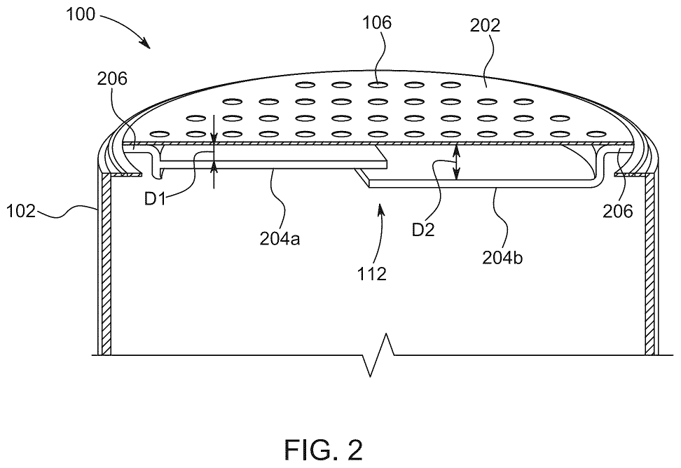

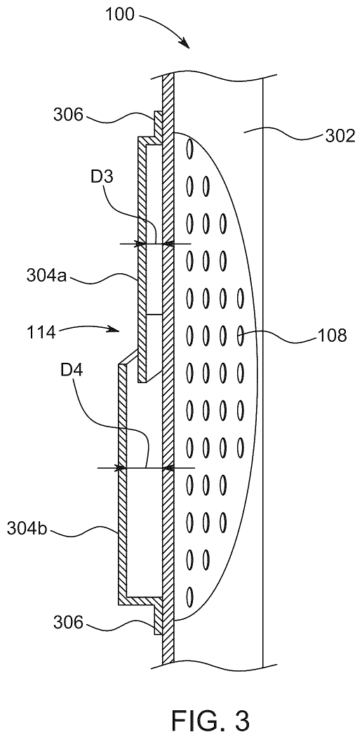

The housing 102 may further include an air inlet 106 and an air outlet 108. In some instances, the air inlet 106 and the air outlet 108 may be disposed in an upper portion of the housing 102 that is disposed above the water storage tank 104. As discussed herein, the upper portion of the housing 102 may be configured to house at least a portion of a heat pump system that forms a vapor compression cycle system. In some aspects, the upper portion of the housing 102 may be an integral part of or removably attached with the housing 102. The air inlet 106 may be configured to receive ambient air from outside and pass the air to the housing interior portion, and the air outlet 108 may be configured to output the air from the housing interior portion to outside of the housing 102. In some instances, the air inlet 106 may be disposed through a housing top wall (shown as housing top wall 202 in FIG. 2), and the air outlet 108 may be disposed through a housing side wall (shown as housing side wall 302 in FIG. 3), or vice versa. In other aspects, the air inlet 106 may be disposed through the housing side wall, opposite to the air outlet 108. The air inlet 106 and the air outlet 108 may be disposed at any suitable location about the housing 102. In some aspects, the air inlet 106 and/or the air outlet 108 may include a single opening. In further aspects, the air inlet 106 and/or the air outlet 108 may include a plurality of openings/apertures/vents that collectively form the respective air inlet 106 and the air outlet 108. In further aspects, the air inlet 106 and/or the air outlet 108 may be an opening with a grate or mesh type structure covering the opening. The air inlet 106 and/or the air outlet 108 may be of any shape, for example, the air inlet 106 and/or the air outlet 108 may be circular in shape. In some aspects, the housing 102 may include a plurality of air inlets and a plurality of air outlets.

The water heating device 100 may further include a heating source. In some aspects, the heating source may be a heat pump assembly. Stated another way, the water heating device 100 may be a heat pump water heater. The heat pump assembly (or heat pump) may include, among other things, a fan, an evaporator, a compressor 110, a heat exchanger/condenser coils, and a refrigerant conduit that distributes a refrigerant to different heat pump assembly components. The heat pump assembly may collectively form a vapor compression cycle system. The various heat pump assembly components may be sized, shaped, and located as would be suitable for the particular application. As will be appreciated, the various heat pump assembly components may be sized for residential, commercial, or industrial applications and for heating water within various temperature ranges and within various time ranges. In some aspects, the heat pump assembly may be at least partially located inside the housing 102.

The fan may draw ambient air from outside of the housing and may pass the air (via the air inlet 106) to the evaporator that may absorb heat from the ambient air. The evaporator may include a plurality of coils that contain the refrigerant. The refrigerant may absorb heat from the ambient air and may evaporate. In some aspects, the refrigerant may be in liquid form and may change state from liquid to vapor when the refrigerant absorbs heat from the ambient air. The vaporized refrigerant may move to the compressor 110 that may raise pressure and temperature of the refrigerant. In some aspects, the compressor 110 may be a pump that provides additional pressure to the refrigerant to enable the refrigerant to flow through the refrigerant conduit (in a defined path).

The compressor 110 may be of any suitable type. For example, the compressor 110 may be a positive displacement compressor, a reciprocating compressor, a rotary screw compressor, a rotary vane compressor, a rolling piston compressor, a scroll compressor, an inverter compressor, a diaphragm compressor, a dynamic compressor, an axial compressor, or any other form of compressor that can be integrated into the heat pump assembly for the particular application.

The compressed refrigerant from the compressor 110 may move to the heat exchanger/condenser coils that may enable transfer of energy/heat to the water in the water storage tank 104, thus heating the water. In some aspects, the condenser coils may be wrapped around the water storage tank exterior surface or submerged in the tank. Responsive to the water being heated, cool and dehumidified air may move out of the housing 102 via the air outlet 108.

In certain embodiments, the water heating device 100 may further include an inlet muffler 112 and/or an outlet muffler 114. In some instances, the inlet muffler 112 may be disposed between the compressor 110 and the air inlet 106, and the outlet muffler 114 may be disposed between the compressor 110 and the air outlet 108. As described above, the air inlet 106 and the air outlet 108 may be disposed at any suitable location in the housing 102. Thus, the inlet muffler 112 and the outlet muffler 114 may be disposed in any air inlet/air outlet position. In some aspects, the housing 102 may include a plurality of air inlets and a plurality of air outlets, each having its own muffler.

The inlet muffler 112 and the outlet muffler 114 may be configured to allow air to flow between the air inlet 106, the heat pump assembly, and the air outlet 108, but prevent (or limit) sound transmission from the heat pump (e.g., the compressor 110) to the outside of the housing. Stated another way, the inlet muffler 112 and the outlet muffler 114 may not provide a direct path to transmit the noise from the compressor 110 to the outside (e.g., via the air inlet 106 and the air outlet 108). In some aspects, the inlet muffler 112 and the outlet muffler 114 may be rigid structures, e.g., having plate-like structures. In some instances, the inlet muffler 112 and the outlet muffler 114 may be made of any material including, but not limited to, aluminum, steel, fiberglass, plastic, ceramics, composites, or combinations thereof. In some aspects, the inlet muffler 112 and the outlet muffler 114 may be coated with any material including, but not limited to, foam, vinyl, mass loaded vinyl, etc., or combinations thereof. The details of the inlet muffler 112 and the outlet muffler 114 may be understood in conjunction with FIGS. 2 and 3.

FIG. 2 depicts a sectional top view of the water heater 100 in accordance with one or more embodiments of the present disclosure. Specifically, FIG. 2 shows the inlet muffler 112 disposed in proximity to the housing top wall 202 (or in proximity to the air inlet 106) and may be removably attached to the housing top wall 202.

In some aspects, the inlet muffler 112 may include a first inlet baffle plate 204a and a second inlet baffle plate 204b, which may be disposed parallel to each other. In some aspects, the first inlet baffle plate 204a and the second inlet baffle plate 204b may be solid or rigid structures. In some aspects, the first inlet baffle plate 204a and the second inlet baffle plate 204b may be disposed transverse to the air inlet 106. In other aspects, the first inlet baffle plate 204a and the second inlet baffle plate 204b may be disposed at a predefined angle with respect to the air inlet 106. The predefine angle may be in a range of 0 to 30 degrees. Any suitable angle may be used herein. The first inlet baffle plate 204a may be disposed at a first predetermined distance “D1” (e.g., 0.25 inches to 3 inches) from the air inlet 106, and the second inlet baffle plate 204b may be disposed at a second predetermined distance “D2” (e.g., 0.5 inches to 6 inches) from the air inlet 106. D1 and D2 may be any suitable distance. The first predetermined distance D1 may be different from the second predetermined distance D2. Stated another way, a gap may exist between the first inlet baffle plate 204a and the second inlet baffle plate 204b that may enable air to enter from the air inlet 106 to housing interior portion. In some instances, the gap may be 0.25 to 3 inches. The gap may be any suitable distance.

The first inlet baffle plate 204a and the second inlet baffle plate 204b may be of any size, shape, or configuration. In some instances, the places may be 0.1 inch to 2 inches thick. The plates may be any suitable thickness. The shape and size of the first inlet baffle plate 204a may be the same as the shape and size of the second inlet baffle plate 204b. The shape and size of the first inlet baffle plate 204a and the second inlet baffle plate 204b may correspond to the shape and size of the air inlet 106. In an exemplary aspect, the first inlet baffle plate 204a and the second inlet baffle plate 204b may be shaped as a semi-circle, and the air inlet 106 may be circular. The first inlet baffle plate 204a and the second inlet baffle plate 204b may be disposed such that the first inlet baffle plate 204a and the second inlet baffle plate 204b may completely cover the air inlet 106 to prevent sound transmission from the compressor 110 to the outside. In this manner, the first inlet baffle plate 204a and the second inlet baffle plate 204b may overlap at their respective ends. For example, in some instances, the first inlet baffle plate 204a and the second inlet baffle plate 204b may be disposed to form a circle and completely cover the air inlet 106 from inside of the housing 102. In some instances, the width of the air gap at the overlapping ends of the first inlet baffle plate 204a and the second inlet baffle plate 204b may be D2 minus D1.

In some aspects, the first inlet baffle plate 204a and the second inlet baffle plate 204b may be integrated with each other to form a unified piece (having a gap between the first inlet baffle plate 204a and the second inlet baffle plate 204b), and the unified piece may be attached to the housing top wall 202 (or housing side wall). The unified piece may be attached to the housing top wall 202 using an adhesive or fasteners including, but not limited to, screws, bolts, and/or the like. In further aspects, the unified piece may be integrated to the housing top wall 202. In other aspects, each of the first inlet baffle plate 204a and the second inlet baffle plate 204b may be removably attached to the housing top wall 202 using the fasteners or the adhesive. In further aspects, the first inlet baffle plate 204a and the second inlet baffle plate 204b may be attached the housing top wall 202 by using one or more connectors 206. In an exemplary aspect, the connectors 206 may be “L-shaped” brackets or any other shaped brackets. Further, the connectors 206 may be integrated or removably attached to the first inlet baffle plate 204a and/or the second inlet baffle plate 204b. In further aspects, each of the first inlet baffle plate 204a and the second inlet baffle plate 204b may be integrated to the housing top wall 202.

FIG. 3 depicts a sectional side view of the water heater 100 in accordance with one or more embodiments of the present disclosure. Specifically, FIG. 3 shows the outlet muffler 114 that may disposed in proximity to a housing side wall 302 (or in proximity to the air outlet 108) and may be removably attached to the housing side wall 302. The configuration of the outlet muffler 114 may be similar to the configuration of the inlet muffler 112.

In some aspects, the outlet muffler 114 may include a first outlet baffle plate 304a and a second outlet baffle plate 304b, which may be disposed parallel to each other. In some aspects, the first outlet baffle plate 304a and the second outlet baffle plate 304b may be solid or rigid structures. The first outlet baffle plate 304a and the second outlet baffle plate 304b may be disposed transverse to the air outlet 108. In some aspects, the first outlet baffle plate 304a and the second outlet baffle plate 304b may be disposed at a predefined angle (e.g., in a range of 0 to 30 degrees) with respect to the air outlet 108. Any suitable angle may be used herein. The first outlet baffle plate 304a may be disposed at a third predetermined distance “D3” (e.g., 0.25 inches to 3 inches) from the air outlet 108, and the second outlet baffle plate 304b may be disposed at a fourth predetermined distance “D4” (e.g., 0.5 inches to 6 inches) from the air outlet 108. D3 and D4 may be any suitable distance. The third predetermined distance D3 may be different from the fourth predetermined distance D4. Stated another way, a gap may exist between the first outlet baffle plate 304a and the second inlet baffle plate 304b that may enable air to exit from the housing interior portion via the air outlet 108. In some instances, the gap may be 0.25 to 3 inches. The gap may be any suitable distance.

The first outlet baffle plate 304a and the second outlet baffle plate 304b may be of any suitable size, shape, or configuration. In some instances, the places may be 0.1 inch to 2 inches thick. The plates may be any suitable thickness. The shape and size of the first outlet baffle plate 304a may be the same as the shape and size of the second outlet baffle plate 304b. The shape and size of the first outlet baffle plate 304a and the second outlet baffle plate 304b may correspond to shape and size of the air outlet 108. In an exemplary aspect, the first outlet baffle plate 304a and the second outlet baffle plate 304b may be semi-circular, and the air outlet 108 may be circular. The first outlet baffle plate 304a and the second outlet baffle plate 304b may be disposed such that the first outlet baffle plate 304a and the second outlet baffle plate 304b may completely cover the air outlet 108 to prevent sound transmission from the compressor 110 to the outside. In this manner, the first outlet baffle plate 304a and the second outlet baffle plate 304b may overlap at their respective ends. For example, the first outlet baffle plate 304a and the second outlet baffle plate 304b may be disposed to form a circle and completely cover the air outlet 108 from inside of the housing 102. In some instances, the width of the air gap at the overlapping ends of the first outlet baffle plate 304a and the second outlet baffle plate 304b may be D4 minus D3.

In some instances, the first outlet baffle plate 304a and the second outlet baffle plate 304b may have shapes different from the shapes of the first inlet baffle plate 204a and the second inlet baffle plate 204b. In other aspects, the first outlet baffle plate 304a and the second outlet baffle plate 304b may have shapes equivalent to the shapes of the first inlet baffle plate 204a and the second inlet baffle plate 204b.

In some aspects, the first outlet baffle plate 304a and the second outlet baffle plate 304b may be integrated to each other to form a unified piece (having a gap between the first outlet baffle plate 304a and the second outlet baffle plate 304b), and the unified piece may be attached to the housing side wall 302 (or housing side wall). The unified piece may be attached to the housing side wall 302 using an adhesive or fasteners including, but not limited to, screws, bolts, and/or the like. In further aspects, the unified piece may be integrated to the housing side wall 302. In other aspects, each of the first inlet baffle plate 304a and the second inlet baffle plate 304b may be removably attached to the housing side wall 302 using the fasteners or the adhesive. In further aspects, the first outlet baffle plate 304a and the second outlet baffle plate 304b may be attached the housing side wall 302 by using one or more connectors 306. In an exemplary aspect, the connectors 306 may be “L-shaped” brackets or any other shaped brackets. Further, the connectors 306 may be integrated or removably attached to the first outlet baffle plate 304a and the second outlet baffle plate 304b. In further aspects, each of the first outlet baffle plate 304a and the second outlet baffle plate 304b may be integrated to the housing side wall 302.

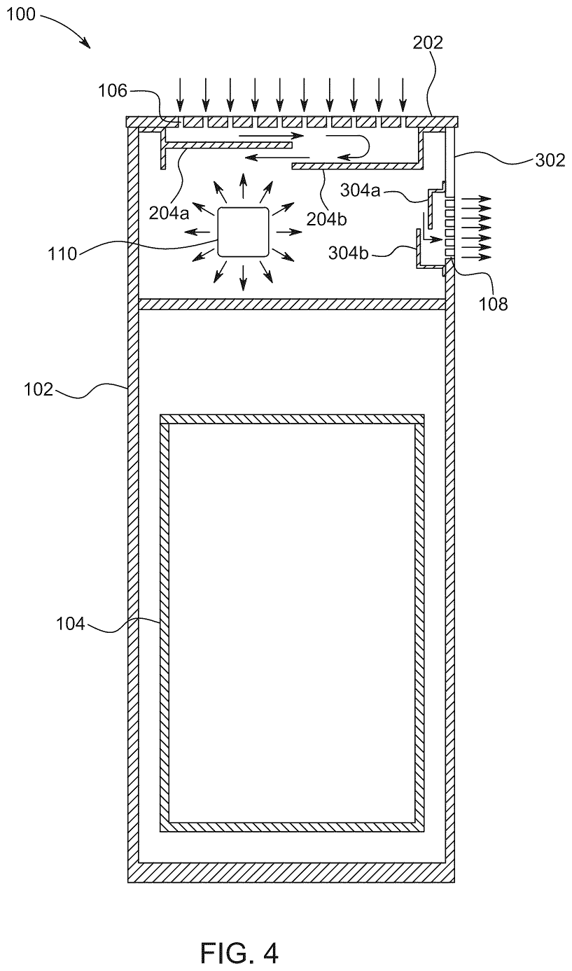

FIG. 4 depicts a sectional front view of the water heater 100 in accordance with one or more embodiments of the present disclosure. Specifically, FIG. 4 depicts the flow of air and sound waves when the water heater 100 may be operational.

In operation, the water heater 100 may intake ambient air through the air inlet 106 via the fan, as described above in conjunction with FIG. 1. When the ambient air enters through the air inlet 106, the ambient air may enter through the inlet muffler 112 and may enter the housing 102. Specifically, the ambient air may enter through the first inlet baffle plate 204a and the second inlet baffle plate 204b, and may enter the housing 102. For example, the ambient air may move through the gap between the first inlet baffle plate 204a and the second inlet baffle plate 204b.

The water heater 100 may use the ambient air to heat water in the water storage tank 104, as described above in conjunction with FIG. 1. Specifically, the water heater 100 may extract heat from the ambient air, heat the water in the water storage tank 104, and may exhaust cool and dehumidified air to the outside of the housing 102 via the outlet muffler 114 and the air outlet 108. For example, the exhaust air may move through the first outlet baffle plate 304a and the second outlet baffle plate 304b and then flow outside of (or exit) the housing 102 via the air outlet 108.

In this manner, the inlet muffler 112 and the outlet muffler 114 may allow ambient air to enter into the housing 102 via the air inlet 106 and exhaust air to exit from the housing 102 via the air outlet 108. However, the inlet muffler 112 and the outlet muffler 114 may prevent sound waves generated by the compressor 110 from exiting out of the housing 102. Specifically, the first inlet baffle plate 204a and the second inlet baffle plate 204b may not provide a direct path for the sound waves to travel from the compressor 110 to the outside via the air inlet 106, and may reflect back the sound waves to the housing interior portion. For example, the ends of the first inlet baffle plate 204a and the second inlet baffle plate 204b may sufficiently overlap (e.g., 1 to 10 inches) to prevent a direct line of sight for the sounds waves to exit the housing 102 out of the air inlet 106. That is, the sound waves will be deflected back into the housing 102 by either the first inlet baffle plate 204a and/or the second inlet baffle plate 204b. The gap, however, between the first inlet baffle plate 204a and the second inlet baffle plate 204b allows for air to travel from the air inlet 106, past the first inlet baffle plate 204a and the second inlet baffle plate 204b, and into the housing 102.

Similarly, the first outlet baffle plate 304a and the second outlet baffle plate 304b may not provide a direct path for the sound waves to travel from the compressor 110 to the outside of the housing 102 via the air outlet 108, and may reflect back the sound waves to the housing interior portion. For example, the ends of the first outlet baffle plate 304a and the second outlet baffle plate 304b may sufficiently overlap (e.g., 1 to 10 inches) to prevent a direct line of sight for the sounds waves to exit the housing 102 out of the air outlet 108. That is, the sound waves will be deflected back into the housing 102 by either the first outlet baffle plate 304a and/or the second outlet baffle plate 304b. The gap, however, between the first outlet baffle plate 304a and the second outlet baffle plate 304b allows for air to travel from the interior of the housing 102, past the first outlet baffle plate 304a and the second outlet baffle plate 304b, and out of the housing 102 via the air outlet 108.

Thus, the inlet muffler 112 and the outlet muffler 114 minimize noise transmission from the water heater 100.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A heat pump water heater comprising:
a housing comprising an air inlet and an air outlet;
a compressor disposed within the housing; and
a first muffler disposed between the compressor and either the air inlet or the air outlet, wherein the first muffler is configured to reflect sound generated by the compressor back into the housing.

2. The heat pump water heater of claim 1, wherein the first muffler comprises a first baffle plate and a second baffle plate.

3. The heat pump water heater of claim 2, wherein the first baffle plate is disposed parallel to the second baffle plate.

4. The heat pump water heater of claim 2, wherein the air inlet and the air outlet are disposed through a housing top wall or a housing side wall.

5. The heat pump water heater of claim 4, wherein the first baffle plate is disposed at a first predetermined distance from the housing top wall or side wall, and the second baffle plate is disposed at a second predetermined distance from the housing top wall or side wall, and wherein the first predetermined distance is different from the second predetermined distance.

6. The heat pump water heater of claim 5, wherein the first baffle plate and the second baffle plate are removably attached to the housing top wall or side wall.

7. The heat pump water heater of claim 5, wherein the first baffle plate and the second baffle plate are disposed transverse to the air inlet or the air outlet.

8. The heat pump water heater of claim 2, wherein a first baffle plate shape is same as a second baffle plate shape.

9. The heat pump water heater of claim 4 further comprising a second muffler disposed between the compressor and other of the air inlet or the air outlet.

10. The heat pump water heater of claim 9, wherein the second muffler comprises a third baffle plate and a fourth baffle plate.

11. The heat pump water heater of claim 10, wherein the third baffle plate is disposed parallel to the fourth baffle plate.

12. The heat pump water heater of claim 10, wherein the third baffle plate is disposed at a third predetermined distance from the housing side wall or top wall, and the fourth baffle plate is disposed at a fourth predetermined distance from the housing side wall or top wall, and wherein the third predetermined distance is different from the fourth predetermined distance.

13. The heat pump water heater of claim 12, wherein the third baffle plate and the fourth baffle plate are removably attached to the housing side wall or top wall.

14. The heat pump water heater of claim 12, wherein the third baffle plate and the fourth baffle plate are disposed transverse to the air inlet or the air outlet.

15. The heat pump water heater of claim 12, wherein a third baffle plate shape is same as a fourth baffle plate shape.

16. A heat pump water heater comprising:
a housing comprising an air inlet and an air outlet;
a compressor disposed within the housing; and
a first muffler disposed between the compressor and either the air inlet or the air outlet, wherein the first muffler is configured to allow air to enter or exit the housing but reflect sound generated by the compressor back into the housing, and wherein the first muffler comprises a first baffle plate and a second baffle plate that are disposed parallel to one another and at least partially overlap one another.

17. The heat pump water heater of claim 16 further comprising a second muffler disposed between the compressor and other of the air inlet or the air outlet.

18. The heat pump water heater of claim 17, wherein the second muffler comprises a third baffle plate and a fourth baffle plate.

19. The heat pump water heater of claim 18, wherein the third baffle plate is disposed parallel to the fourth baffle plate, and wherein the third baffle plate is disposed at a predetermined distance from the fourth baffle plate.

20. A heat pump water heater comprising:
a housing comprising an air inlet and an air outlet;
a compressor disposed within the housing;
an inlet muffler disposed between the compressor and the air inlet; and
an outlet muffler disposed between the compressor and the air outlet,
wherein the inlet muffler and the outlet muffler are configured to allow air to enter or exit the housing but reflect sound generated by the compressor back into the housing.
